(19) United States
(12) Patent Application Publication
(10) Pub. No.: US 2026/0299812 A1
(43) Pub. Date: Oct. 1, 2026

(54) STORAGE DEVICE THAT DETERMINES TARGET OF MIGRATION OPERATION, AND OPERATING METHOD THEREOF

(71) Applicant: SK hynix Inc., Gyeonggi-do (KR)

(72) Inventor: Joo Young LEE, Gyeonggi-do (KR)

(21) Appl. No.: 19/308,326

(22) Filed: Aug. 25, 2025

(30) Foreign Application Priority Data
Mar. 25, 2025 (KR) 10-2025-0037980

(51) Int. Cl. G06F 3/06

(52) U.S. Cl. CPC G06F 3/0647; G06F 3/0611; G06F 3/0659; G06F 3/0679

(57) ABSTRACT

A storage device may include a controller and a memory including a plurality of memory units. The controller may set a plurality of zones each corresponding to at least one of the plurality of memory units, determine a fragmentation value of each of the plurality of zones based on mapping information between a logical address area and a physical address area for a data unit written to each of the plurality of zones, and determine, as a target of a first migration operation, one or more first target memory units among the plurality of memory units based on the fragmentation value of each of the plurality of zones.

### CROSS-REFERENCE TO RELATED APPLICATION

The present application claims priority under 35 U.S.C. § 119(a) to Korean Patent Application No. 10-2025-0037980 filed on Mar. 25, 2025, which is incorporated herein by reference in its entirety.

### BACKGROUND

### 1. Technical Field

Embodiments of the present disclosure relate to a storage device that determines a target of a migration operation, and an operating method thereof.

### 2. Related Art

A storage device stores data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (i.e., a host), and execute or control operations to read, write, or erase data in the memory included in the storage device according to the received command.

A storage device may set a plurality of zones in a memory and write data to the plurality of zones. When data is sequentially written to the plurality of zones, read performance for the data stored in the plurality of zones may be improved.

### SUMMARY

Embodiments of the present disclosure are directed to providing a storage device and an operating method thereof capable of improving read performance for data stored in a plurality of zones.

Objects of embodiments of the disclosure are not limited to those set forth herein, and other unmentioned objects would be apparent to one of ordinary skill in the art from the following description.

In an embodiment, a storage device may include: a memory including a plurality of memory units; and a controller configured to set a plurality of zones each corresponding to at least one of the plurality of memory units, set a plurality of zones each corresponding to at least one of the plurality of memory units, determine a fragmentation value of each of the plurality of zones based on mapping information between a logical address area and a physical address area for a data unit written to each of the plurality of zones, and determine, as a target of a first migration operation, one or more first target memory units among the plurality of memory units based on the fragmentation value of each of the plurality of zones.

In an embodiment, a method of operating a storage device may include: setting a plurality of zones each corresponding to at least one of a plurality of memory units; determining a fragmentation value of each of the plurality of zones based on mapping information between a logical address area and a physical address area for a data unit written to each of the plurality of zones; and determining, as a target of a first migration operation, one or more first target memory units among the plurality of memory units based on the fragmentation value of each of the plurality of zones.

According to embodiments of the present disclosure, a storage device can improve read performance for data stored in a plurality of zones.

The effects of the disclosure are not limited to the foregoing objects, and other effects will be apparent to one of ordinary skill in the art from the following detailed description.

### BRIEF DESCRIPTION OF THE DRAWINGS

The disclosure will be more fully understood from the following detailed description and the accompanying drawings, which are provided for illustration only and are not intended to limit the disclosure.

FIG. 1 illustrates a storage device according to an embodiment of the present disclosure.

FIG. 2 illustrates a memory of FIG. 1, according to an embodiment of the present disclosure.

FIG. 3 is a diagram illustrating a schematic operation of the storage device, according to an embodiment of the present disclosure.

FIG. 4 is a diagram illustrating an operation of the storage device that determines first target memory units, according to an embodiment of the present disclosure.

FIG. 5 is a diagram illustrating an operation of the storage device that determines second target memory units, according to an embodiment of the present disclosure.

FIG. 6 is a diagram illustrating a first level map and a second level map according to an embodiment of the present disclosure.

FIG. 7 is a diagram illustrating an example of an operation of the storage device that determines a fragmentation value, according to an embodiment of the present disclosure.

FIG. 8 is a diagram illustrating another example of the operation of the storage device that determines a fragmentation value, according to an embodiment of the present disclosure.

FIG. 9 is a flowchart illustrating an example of an operation of the storage device that determines the ratio of the number of second target memory units to the number of first target memory units, according to an embodiment of the present disclosure.

FIG. 10 is a diagram illustrating an operation of the storage device that determines first target memory units in a first zone, according to an embodiment of the present disclosure.

FIG. 11 is a diagram illustrating an operation of the storage device that executes a first migration operation, according to an embodiment of the present disclosure.

FIG. 12 is a flowchart illustrating a method of operating the storage device according an embodiment of to the present disclosure.

### DETAILED DESCRIPTION

Hereinafter, embodiments of the present disclosure are described in detail with reference to the accompanying drawings. Throughout the specification, reference to “an embodiment,” “another embodiment” or the like is not necessarily to only one embodiment, and different references to any such phrase are not necessarily limited to the same embodiment(s). The term “embodiments” when used herein does not necessarily refer to all embodiments.

Various embodiments of the present disclosure are described below in more detail with reference to the accompanying drawings. However, the present disclosure may be embodied in different forms and variations, and should not be construed as being limited to the embodiments set forth herein. Rather, the described embodiments are provided so that this disclosure will be thorough and complete, and will fully convey the present disclosure to those skilled in the art to which this disclosure pertains. Throughout the disclosure, like reference numerals refer to like parts throughout the various figures and embodiments of the present disclosure.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device.

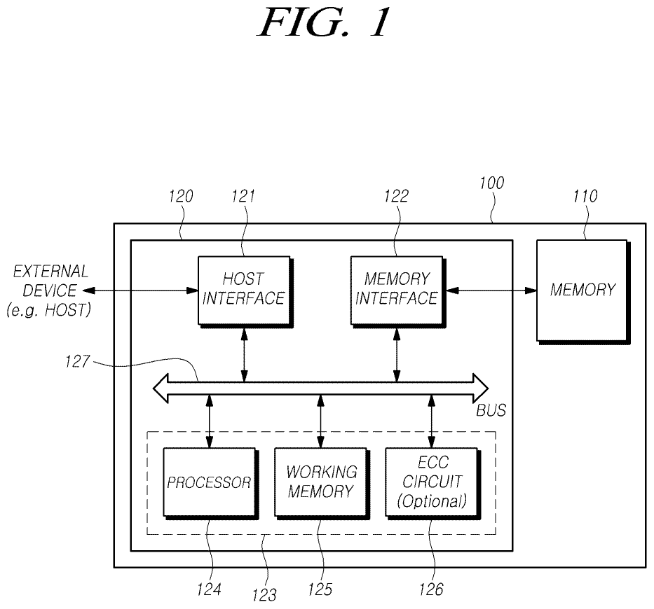

FIG. 1 illustrates a storage device 100 according to an embodiment of the present disclosure.

Referring to FIG. 1, the storage device 100 may include a memory 110 that stores data and a controller 120 that controls the memory 110.

The memory 110 may include a plurality of memory blocks, and operate under the control of the controller 120. Operations of the memory 110 may include, for example, a read operation, a program operation (also referred to as a write operation), and an erase operation.

The memory 110 may include a memory cell array including a plurality of memory cells (also referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM), a spin transfer torque random access memory (STT-RAM), and so forth.

The memory 110 may be implemented as a three-dimensional array structure. For example, embodiments of the present disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. In other words, the memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (or program), read, erase, and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request from the host.

The host may be a computer, an ultra-mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereafter, for the sake of convenience in explanation, descriptions will describe the controller 120 and the host as devices that are separated from each other.

Referring to FIG. 1, the controller 120 may include a memory interface 122 and a control circuit 123, and may further include a host interface 121.

The host interface 121 may provide an interface for communication with the host. For example, the host interface 121 may provide an interface that uses at least one from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol, and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. More particularly, the memory interface 122 may be configured to provide an interface between the memory 110 and the controller 120 under the control of the control circuit 123.

The control circuit 123 may perform the general control operations of the controller 120 to control the operation of the memory 110. To this end the control circuit 123 may include, for instance, at least one of a processor 124 and a working memory 125, and may optionally include an error detection and correction circuit (ECC circuit (optional)) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Particularly, when controlling the general operation of the controller 120 and performing a logic calculation, the processor 124 may execute (or drive) firmware loaded in the working memory 125 upon booting. Hereafter, an operation of the storage device 100 according to embodiments of the disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined (or stored, retained, provided, etc.).

For example, the firmware may include at least one from among a flash translation layer, which performs a translating function between a logical address requested to the storage device 100 from the host and a physical address of the memory 110, a host interface layer (HIL), which serves to analyze a command requested to the storage device 100 as a storage device from the host and transfer the command to the flash translation layer, and a flash interface layer (FIL), which transfers a command, instructed by the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata, as data for managing the memory 110, may include, for example, management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one from among an SRAM (static RAM), a DRAM (dynamic RAM) and an SDRAM (synchronous DRAM). Further, the controller 120 may additionally use a separate volatile memory (e.g., SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by (for example, provided as/in, implemented by) various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may denote a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or has failed. On the other hand, when a bit error rate is lower than the reference value, the error detection and correction circuit 126 may determine that a corresponding sector is correctable or has passed.

The error detection and correction circuit 126 may perform an error detection and correction operation sequentially for all read data. In instances in which a sector included in read data is correctable, the error detection and correction circuit 126 may omit an error detection and correction operation for a corresponding sector for next read data. If the error detection and correction operation for all read data is handled in this manner, then the error detection and correction circuit 126 may detect a sector which is uncorrectable in read data last. There may be one or more sectors that are determined to be uncorrectable. The error detection and correction circuit 126 may transfer information (e.g., address information) regarding a sector which is determined to be uncorrectable to the processor 124.

A bus 127 may be configured to provide channels among the components 121, 122, 124, 125, and 126 of the controller 120. The bus 127 may include, for example, a control bus for transferring various control signals, commands and the like, a data bus for transferring various data, and so forth.

Some components among the above-described components 121, 122, 124, 125, and 126 of the controller 120 may be omitted, or some components among the above-described components 121, 122, 124, 125, and 126 of the controller 120 may be integrated into one component. In addition to the above-described components 121, 122, 124, 125, and 126 of the controller 120, one or more other components may be added.

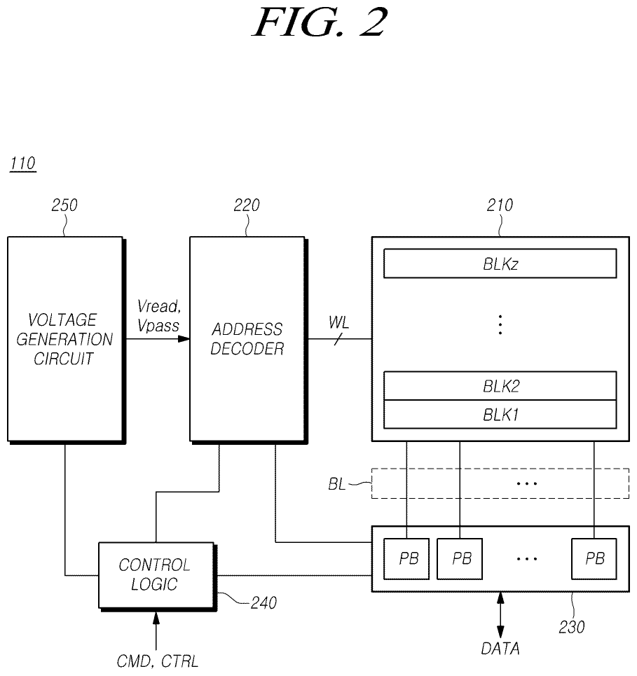

Hereinbelow, the memory 110 will be described in further detail with reference to FIG. 2.

FIG. 2 illustrates the memory 110 of FIG. 1, according to an embodiment of the present disclosure.

Referring to FIG. 2, the memory 110 may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240, and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include at least one from among a block address, a row address and a column address.

The address decoder 220 may select one memory block and one word line depending on a block address and a row address. A column address may be decoded by the address decoder 220 and be provided to the read and write circuit 230.

The address decoder 220 may include at least one from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that perform a data processing function, and may further include cache buffers that perform a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals output from the control logic 240.

In a read operation, the read and write circuit 230 may temporarily store read data by sensing data of memory cells, and then, output data DATA to the input/output buffer of the memory 110. According to an embodiment, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal output from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (or write operation) of the memory block described above may be performed by the unit of a page, and an erase operation may be performed by the unit of a memory block.

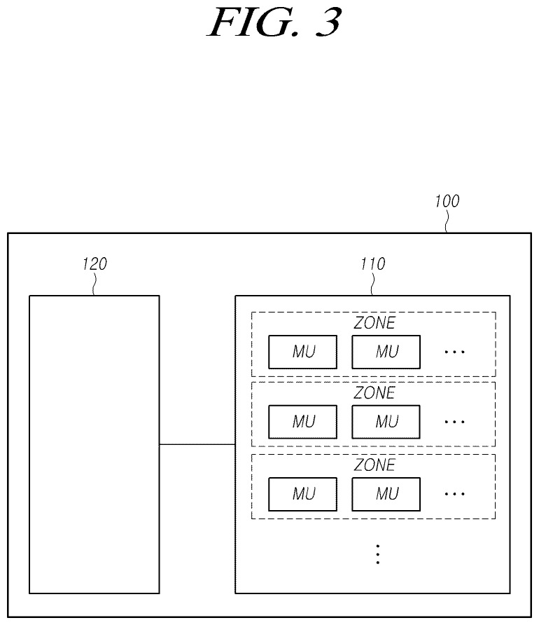

FIG. 3 is a diagram illustrating a schematic operation of the storage device 100 according to an embodiment of the present disclosure.

Referring to FIG. 3, the storage device 100 may include the memory 110 and the controller 120.

The memory 110 may include a plurality of memory units MU. Each of the plurality of memory units MU may store data by dividing the data into data units each having a set size (e.g., 4 KB or 16 KB). The size of a data unit may be a multiple of the storage capacity of a memory block or the storage capacity of a page.

Each of the plurality of memory units MU may include one or more memory blocks or one or more pages. The storage capacities of the plurality of memory units MU may be the same as or different from each other.

The controller 120 may set a plurality of zones ZONE. Each of the plurality of zones ZONE may correspond to at least one of the plurality of memory units MU.

FIG. 3 illustrates as an example a case where the entirety of one memory unit is included in only one zone, but only a part of one memory unit may be included in one zone. In addition, one part of one memory unit may be included in one zone, and the other part may be included in another zone.

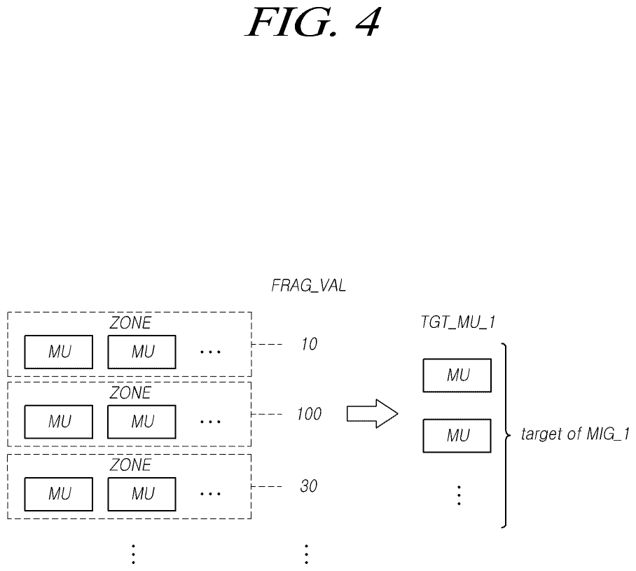

In embodiments of the present disclosure, the controller 120 of the storage device 100 may determine one or more first target memory units as a target of a first migration operation among the plurality of memory units MU. This will be described below in detail with reference to FIG. 4.

The first migration operation is an operation of moving data stored in the first target memory units to other memory units. For example, the first migration operation may be garbage collection, wear leveling, or read reclaim.

FIG. 4 is a diagram illustrating an operation of the storage device 100 that determines first target memory units TGT_MU_1, according to an embodiment of the present disclosure.

Referring to FIG. 4, the controller 120 of the storage device 100 may determine a fragmentation value FRAG_VAL of each of the plurality of zones ZONE. The controller 120 may determine the fragmentation value FRAG_VAL of each of the plurality of zones ZONE on the basis of mapping information between a logical address area and a physical address area for a data unit written to each zone.

The fragmentation value FRAG_VAL of each of the plurality of zones ZONE is a value indicating the degree to which mapping information between a logical address area and a physical address area for a data unit written to each zone is fragmented. In instances in which the fragmentation value FRAG_VAL of a certain zone is greater, this indicates that the degree to which data units written to the corresponding zone are not stored sequentially and are stored by being fragmented is great. The controller 120 may log a situation in which mapping information between a logical address area and a physical address area for a data unit written to each zone is fragmented.

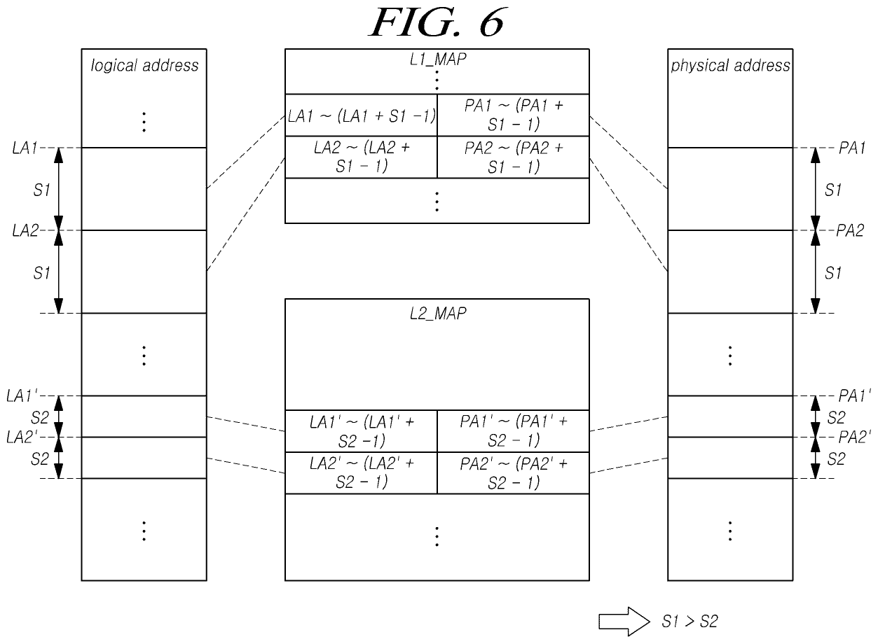

First, when each zone is opened, the controller 120 may initialize the fragmentation value FRAG_VAL of the corresponding zone. Thereafter, when writing a data unit to the corresponding zone, the controller 120 may determine whether to maintain or update the fragmentation value FRAG_VAL of the corresponding zone. This will be described in detail with reference to FIG. 6 to FIG. 8.

In FIG. 4, the controller 120 may determine the respective fragmentation values FRAG_VAL of the plurality of zones ZONE as 10, 100, 30, . . . .

On the basis of the respective fragmentation values FRAG_VAL of the plurality of zones ZONE, the controller 120 may determine the first target memory units TGT_MU_1 as a target of a first migration operation MIG_1.

In embodiments of the present disclosure, the controller 120 of the storage device 100 may additionally determine one or more second target memory units as a target of a second migration operation.

For example, the controller 120 may execute the second migration operation in parallel with or sequentially to the first migration operation. For another example, the controller 120 may determine a ratio at which the second migration operation is executed compared to the first migration operation, on the basis of the proportional value of the first migration operation and the proportional value of the second migration operation.

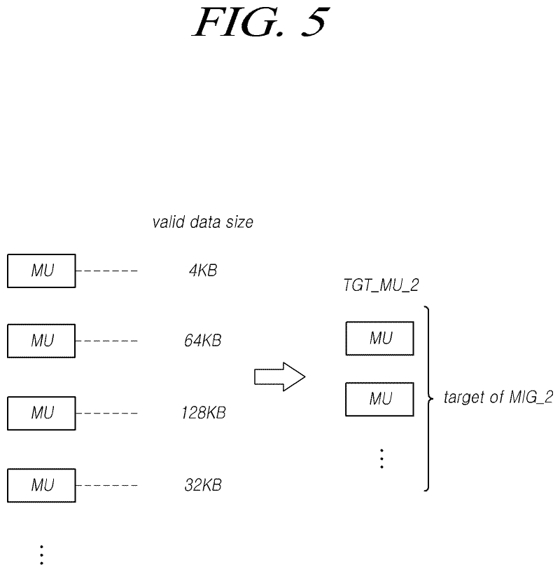

FIG. 5 is a diagram illustrating an operation of the storage device 100 that determines second target memory units TGT_MU_2, according to an embodiment of the present disclosure.

Referring to FIG. 5, the controller 120 of the storage device 100 may calculate the size of valid data stored in each of the plurality of memory units MU. Valid data may be read by a read request from the outside of the storage device 100.

In FIG. 5, the controller 120 may calculate the sizes 4 KB, 64 KB, 128 KB, 32 KB, . . . of valid data stored in the plurality of memory units MU, respectively.

The controller 120 may determine the second target memory units TGT_MU_2 as a target of a second migration operation MIG_2 on the basis of the sizes of valid data stored in the plurality of memory units MU, respectively.

In the above, operations in which the controller 120 of the storage device 100 determines the first target memory units TGT_MU_1 and the second target memory units TGT_MU_2 have been described.

Hereinbelow, a detailed operation in which the controller 120 of the storage device 100 determines the fragmentation value FRAG_VAL of each of the plurality of zones ZONE will be described.

First, descriptions will be made for a first level map and a second level map that are used to manage mapping information between logical address areas and physical address areas for data units written to each of the plurality of zones ZONE.

FIG. 6 is a diagram illustrating a first level map L1_MAP and a second level map L2_MAP according to an embodiment of the present disclosure.

Referring to FIG. 6, the controller 120 of the storage device 100 may generate a first level map L1_MAP that indicates mapping information between a logical address area and a physical address area of a first unit size S1 (e.g., 4 MB or 8 MB), and a second level map L2_MAP that indicates mapping information between a logical address area and a physical address area of a second unit size S2 (e.g., 4 KB or 8 KB).

The first level map L1_MAP and the second level map L2_MAP may be stored in the memory 110. The controller 120 may cache at least one of a part of the first level map L1_MAP and a part of the second level map L2_MAP in a cache set inside the controller 120 to enable faster access to mapping information.

The first unit size S1 may be larger than the second unit size S2. For example, the first unit size S1 may be a multiple of the second unit size S2.

The second unit size S2 may be the size of a data unit stored in the plurality of memory units MU described above.

The first level map L1_MAP may include a plurality of first level map entries. Each of the plurality of first level map entries may indicate that a consecutive logical address area of the first unit size S1 and a consecutive physical address area of the first unit size S1 are mapped to each other.

In FIG. 6, the first level map L1_MAP may indicate that a logical address area LA1 to LA1+S1-1 of the first unit size S1 is mapped to a physical address area PA1 to PA1+S1-1.

In addition, the first level map L1_MAP may indicate that a logical address area LA2 to LA2+S1-1 of the first unit size S1 is mapped to a physical address area PA2 to PA2+S1-1.

The second level map L2_MAP may include a plurality of second level map entries. Each of the plurality of second level map entries may indicate that a consecutive logical address area of the second unit size S2 and a consecutive physical address area of the second unit size S2 are mapped to each other.

In FIG. 6, the second level map L2_MAP may indicate that a logical address area LA1′ to LA1′+S2-1 of the second unit size S2 is mapped to a physical address area PA1′ to PA1′+S2-1.

In addition, the second level map L2_MAP may indicate that a logical address area LA2′ to LA2′+S2-1 of the second unit size S2 is mapped to a physical address area PA2′ to PA2′+S2-1.

In FIG. 6, a case where a logical address area indicated by the first level map L1_MAP and a logical address area indicated by the second level map L2_MAP are separated from each other has been described as an example, but consistent with the present disclosure, a logical address area indicated by the first level map L1_MAP and a logical address area indicated by the second level map L2_MAP may overlap each other.

For example, the logical address area LA1′ to LA1′+S2-1 indicated by the second level map L2_MAP may be included in the logical address area LA1 to LA1+S1-1 indicated by the first level map L1_MAP.

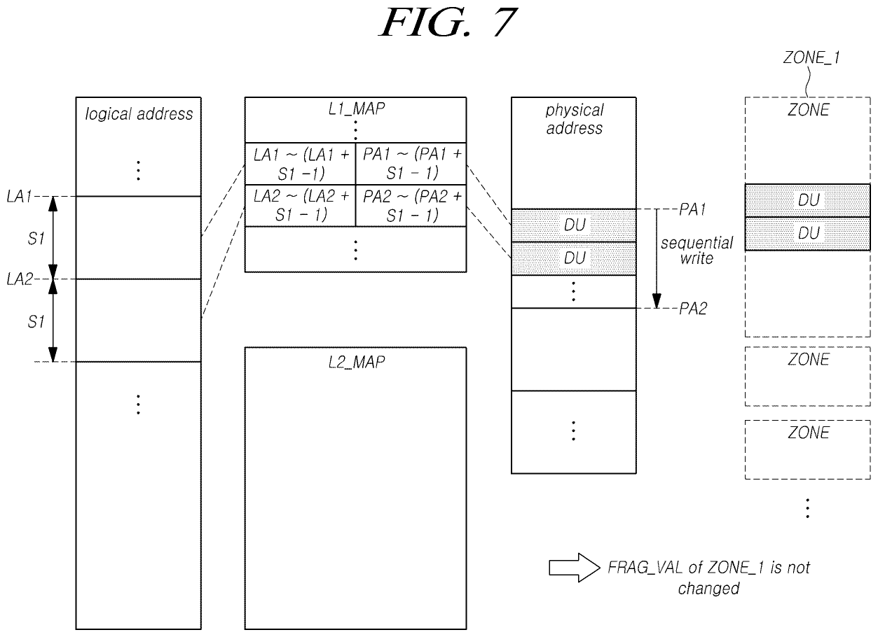

FIG. 7 is a diagram illustrating an example of an operation of the storage device 100 that determines a fragmentation value FRAG_VAL, according to an embodiment of the present disclosure.

Referring to FIG. 7, when writing data units DU to a first zone ZONE_1 among the plurality of zones ZONE, the controller 120 of the storage device 100 may write the data units DU sequentially to the first zone ZONE_1. When the logical address areas of the written data units DU are consecutive to each other, the physical address areas of the corresponding data units DU are also consecutive to each other.

In this case, the controller 120 may indicate mapping information on the data units DU sequentially written to the first zone ZONE_1 using only the first level map L1_MAP, and therefore, does not update the second level map L2_MAP. In instances such as this, the fragmentation value FRAG_VAL for the first zone ZONE_1 is not changed.

When the controller 120 may indicate mapping information using only the first level map L1_MAP, the first unit size S1 may be covered using mapping information between one logical address area and one physical address area. Therefore, the size of mapping information that needs to be cached to read large-sized data may be reduced, and as a result, read performance may be improved.

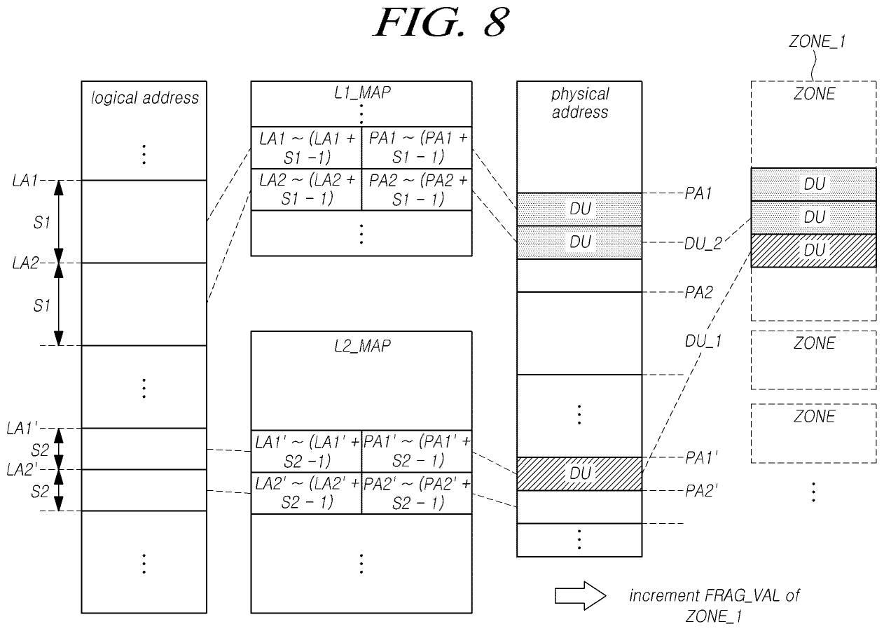

FIG. 8 is a diagram illustrating another example of the operation of the storage device 100 that determines a fragmentation value FRAG_VAL, according to an embodiment of the present disclosure.

Referring to FIG. 8, when the controller 120 of the storage device 100 writes data units DU to the first zone ZONE_1 among the plurality of zones ZONE, a certain data unit may be written non-sequentially with respect to other data units.

For example, when a mixed write request for two or more zones is received from the outside (e.g., from the host) of the storage device 100 or when a sudden power-off (SPO) occurs, a non-sequential write may occur.

In FIG. 8, among the plurality of data units DU written to the first zone ZONE_1, a physical address area where a first data unit DU_1 is written and a physical address area where a second data unit DU_2 is written immediately before the first data unit DU_1 are not consecutive to each other.

In this case, the controller 120 cannot indicate mapping information for the first data unit DU_1 using only the first level map L1_MAP. Therefore, the controller 120 may store mapping information of a logical address area LA1′ to LA1′+S2-1 and a physical address area PA1′ to PA1′+S2-1 for the first data unit DU_1 in the second level map L2_MAP.

In this case, because the second level map L2_MAP is updated, the controller 120 may increase the fragmentation value FRAG_VAL for the first zone ZONE_1.

In embodiments of the present disclosure, as the fragmentation value FRAG_VAL of the first zone ZONE_1 is larger, this denotes that the data units DU stored in the first zone ZONE_1 are fragmented and that the possibility of the second level map L2_MAP to be used to access the data units DU stored in the first zone ZONE_1 is high.

When the controller 120 indicates mapping information using the second level map L1_MAP, only the second unit size S2 smaller than the first unit size S1 may be covered using mapping information between one logical address area and one physical address area. Therefore, the size (e.g., 1 MB) of mapping information that needs to be cached to read large-sized data (e.g., 1 GB) increases, and as a result, read performance may deteriorate.

Accordingly, the controller 120 may determine the first target memory units TGT_MU_1 on the basis of the fragmentation value FRAG_VAL of each of the plurality of zones ZONE, and may migrate data units stored in the first target memory units TGT_MU_1 to other memory units. As a result, by increasing the probability of the first level map L1_MAP to be referred to, read performance may be improved. The controller 120 may perform migration without a request from the outside (e.g., the host) of the storage device 100 to reduce the degree to which data stored in each of the plurality of zones ZONE is fragmented (i.e., a degree of fragmentation).

The storage device 100 may determine the proportion between the first migration operation and the second migration operation described above. In other words (or from another perspective), the storage device 100 may determine the priority between the first migration operation and the second migration operation.

To this end, the storage device 100 may determine the ratio of the number of second target memory units TGT_MU_2 as a target of the second migration operation to the number of first target memory units TGT_MU_1 as a target of the first migration operation. The smaller the determined ratio is, the more the proportion (priority) of the first migration operation increases. On the other hand, the greater the determined ratio is, the more the proportion (priority) of the second migration operation increases.

For example, based on the number of free memory units among the plurality of memory units MU, the controller 120 of the storage device 100 may determine the ratio of the number of second target memory units TGT_MU_2 to the number of first target memory units TGT_MU_1.

In embodiments of the present disclosure, as the number of free memory units is greater (a clean state), the controller 120 may determine the ratio of the number of second target memory units TGT_MU_2 to the number of first target memory units TGT_MU_1 to decrease (i.e., the number of first target memory units TGT_MU_1 to increase).

When the number of free memory units is great, the need to secure free memory units decreases. Therefore, in order to increase read performance for the plurality of zones ZONE, the controller 120 may increase the number of first target memory units TGT_MU_1, and as a result, may increase the proportion of the first migration operation.

On the other hand, as the number of free memory units is small (a dirty state), the controller 120 may determine the ratio of the number of second target memory units TGT_MU_2 to the number of first target memory units TGT_MU_1 to increase (i.e., the number of second target memory units TGT_MU_2 to increase).

When the number of free memory units is small, free memory units should be preferentially secured. Therefore, the controller 120 may increase the number of second target memory units TGT_MU_2, and as a result, may increase the proportion of the second migration operation.

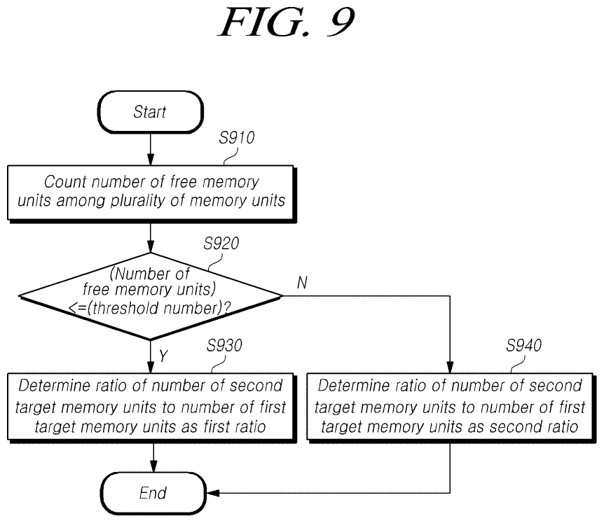

FIG. 9 is a flowchart illustrating an example of an operation of the storage device 100 that determines the ratio of the number of second target memory units TGT_MU_2 to the number of first target memory units TGT_MU_1, according to an embodiment of the present disclosure.

Referring to FIG. 9, the controller 120 of the storage device 100 may count the number of free memory units among the plurality of memory units MU (operation S910).

The controller 120 determines whether the number of free memory units counted in the operation S910 is equal to or smaller than a threshold number (operation S920). The threshold number may be a preset value or a value that is determined depending on the state of the storage device 100.

When the number of free memory units is equal to or smaller than the threshold number (i.e., “Y” in the operation S920), the controller 120 may determine the ratio of the number of second target memory units TGT_MU_2 to the number of first target memory units TGT_MU_1 as a first ratio (operation S930).

On the other hand, when the number of free memory units is greater than the threshold number (i.e., “N” in the operation S920), the controller 120 may determine the ratio of the number of second target memory units TGT_MU_2 to the number of first target memory units TGT_MU_1 as a second ratio (operation S940).

The first ratio is greater than the second ratio. In other words, as the number of free memory units is greater, in order to improve read performance for the plurality of zones ZONE, the controller 120 may increase the number of first target memory units TGT_MU_1 to increase the proportion of the first migration operation.

On the other hand, in instances in which the number of free memory units is smaller, in order to quickly secure free memory units, the controller 120 may increase the number of second target memory units TGT_MU_2 to increase the proportion of the second migration operation.

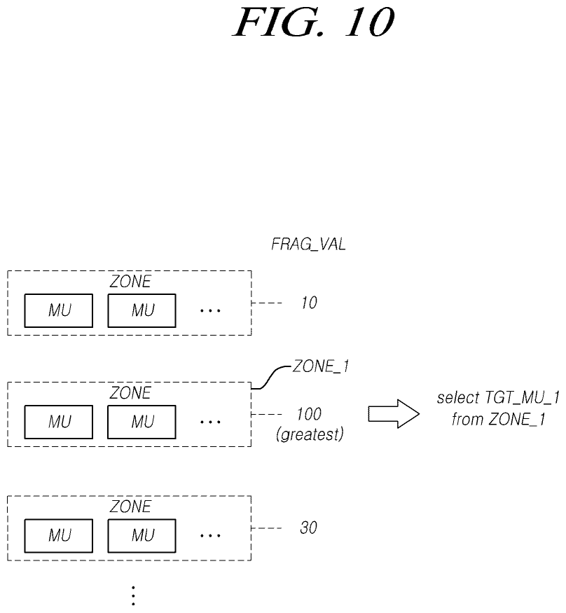

FIG. 10 is a diagram illustrating an operation of the storage device 100 that determines first target memory units TGT_MU_1 in a first zone ZONE_1, according to an embodiment of the present disclosure.

Referring to FIG. 10, the controller 120 of the storage device 100 may determine memory units MU corresponding to the first zone ZONE_1 with a greatest fragmentation value FRAG_VAL of 100 among the plurality of zones ZONE as the first target memory units TGT_MU_1.

The fact that the fragmentation value FRAG_VAL of the first zone ZONE_1 is greatest indicates that the size of the mapping information of the second level map L2_MAP to be referred to in order to access data units stored in the first zone ZONE_1 is the largest.

Therefore, the controller 120 may execute the first migration operation for the memory units MU corresponding to the first zone ZONE_1 to thereby allow only the first level map L1_MAP to be referred to in order to access the data units stored in the first zone ZONE_1.

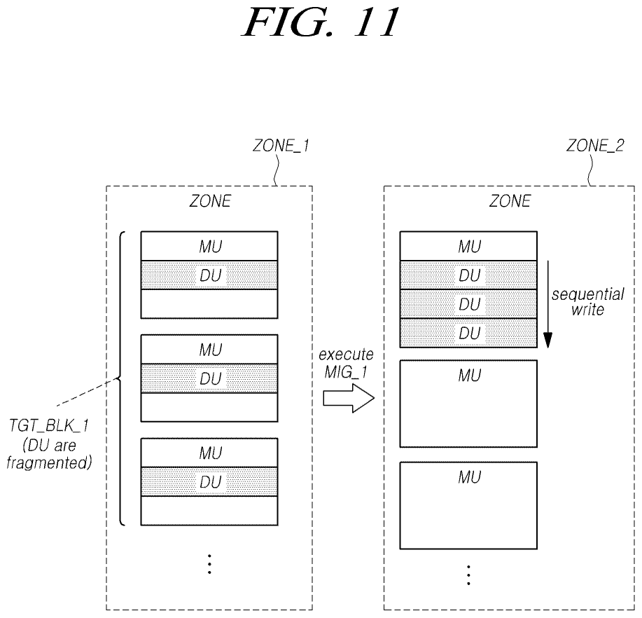

FIG. 11 is a diagram illustrating an operation of the storage device 100 that executes a first migration operation MIG_1, according to an embodiment of the present disclosure.

Referring to FIG. 11, when executing the first migration operation MIG_1, the controller 120 of the storage device 100 may sequentially migrate the data units DU stored in the first target memory units TGT_MU_1 to a second zone ZONE_2 among the plurality of zones ZONE.

In this case, data units DU corresponding to consecutive logical address areas may be stored in consecutive physical address areas.

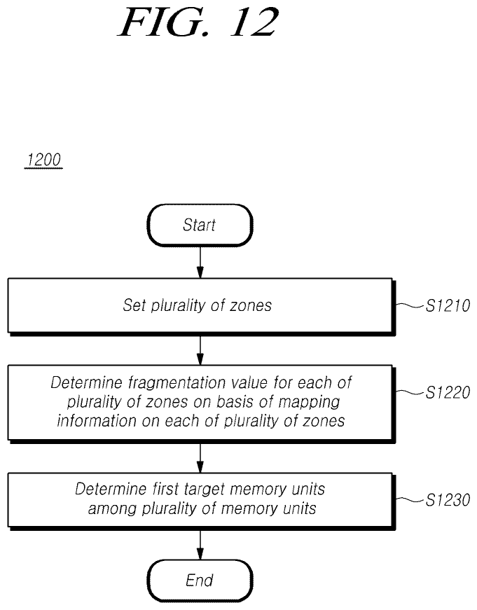

FIG. 12 is a flowchart illustrating a method of operating the storage device 100 according to an embodiment of the present disclosure.

Referring to FIG. 12, a method 1200 of operating the storage device 100 may include an operation S1210 of setting a plurality of zones ZONE each corresponding to one or more of a plurality of memory units MU.

The method 1200 of operating the storage device 100 may include an operation S1220 of determining the fragmentation value FRAG_VAL of each of the plurality of zones ZONE on the basis of mapping information between a logical address area and a physical address area for a data unit DU written to each of the plurality of zones ZONE.

For example, mapping information may be stored in at least one of a first level map L1_MAP that indicates mapping information between a logical address area and a physical address area of a first unit size S1 and a second level map L2_MAP that indicates mapping information between a logical address area and a physical address area of a second unit size S2. The first unit size S1 is larger than the second unit size S2.

The method 1200 of operating the storage device 100 may include an operation S1230 of determining one or more first target memory units TGT_MU_1 as a target of a first migration operation MIG_1 among a plurality of memory units MU on the basis of the fragmentation value FRAG_VAL of each of the plurality of zones ZONE.

For example, when the second level map L2_MAP is updated by an operation of writing a first data unit DU_1 to a first zone ZONE_1 among the plurality of zones ZONE, the operation S1230 may increase the fragmentation value FRAG_VAL of the first zone ZONE_1.

When a physical address area where the first data unit DU_1 is written in the first zone ZONE_1 and a physical address area where a second data unit DU_2 written immediately before the first data unit DU_1 in the first zone ZONE_1 are not consecutive to each other, the second level map L2_MAP may be updated.

For example, the operation S1230 may determine memory units corresponding to the first zone ZONE_1 with a greatest fragmentation value FRAG_VAL among the plurality of zones ZONE as the first target memory units TGT_MU_1.

The method 1200 of operating the storage device 100 may further include an operation of sequentially migrating, when executing the first migration operation MIG_1, data units stored in the first target memory units TGT_MU_1 to a second zone ZONE_2 among the plurality of zones ZONE.

The method 1200 of operating the storage device 100 may further include an operation of determining one or more second target memory units TGT_MU_2 as a target of a second migration operation MIG_2 among the plurality of memory units MU on the basis of the size of valid data stored in each of the plurality of memory units MU; and an operation of determining the ratio of the number of second target memory units TGT_MU_2 to the number of first target memory units TGT_MU_1 on the basis of the number of free memory units among the plurality of memory units MU.

For example, the operation of determining the ratio of the number of second target memory units TGT_MU_2 to the number of first target memory units TGT_MU_1 may determine the ratio as a first ratio when the number of free memory units among the plurality of memory units MU is equal to or smaller than a threshold number, and may determine the ratio as a second ratio when the number of free memory units among the plurality of memory units MU is greater than the threshold number. The first ratio is greater than the second ratio.

Although exemplary embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. A storage device comprising:
a memory including a plurality of memory units; and
a controller configured to
set a plurality of zones each corresponding to at least one of the plurality of memory units,
determine a fragmentation value of each of the plurality of zones based on mapping information between a logical address area and a physical address area for a data unit written to each of the plurality of zones, and
determine, as a target of a first migration operation, one or more first target memory units among the plurality of memory units based on the fragmentation value of each of the plurality of zones.

2. The storage device according to claim 1, wherein the controller is further configured to:
generate a first level map that indicates mapping information between a logical address area and a physical address area of a first unit size, and a second level map that indicates mapping information between a logical address area and a physical address area of a second unit size, the first unit size being larger than the second unit size; and
increase, when the second level map is updated by an operation of writing a first data unit to a first zone among the plurality of zones, a fragmentation value of the first zone.

3. The storage device according to claim 2, wherein, when a physical address area where the first data unit is written in the first zone and a physical address area where a second data unit written immediately before the first data unit in the first zone are not consecutive to each other, the controller is configured to update the second level map.

4. The storage device according to claim 1, wherein the controller is further configured to:
determine, as a target of a second migration operation, one or more second target memory units among the plurality of memory units based on the size of valid data stored in each of the plurality of memory units; and
determine the ratio of a number of the second target memory units to a number of the first target memory units based on a number of free memory units among the plurality of memory units.

5. The storage device according to claim 4, wherein the controller is further configured to:
determine the ratio as a first ratio when the number of free memory units among the plurality of memory units is equal to or smaller than a threshold number; and
determine the ratio as a second ratio when the number of free memory units among the plurality of memory units is greater than the threshold number, the first ratio being greater than the second ratio.

6. The storage device according to claim 1, wherein the controller is configured to determine, as the first target memory units, memory units corresponding to a first zone with a greatest fragmentation value among the plurality of zones.

7. The storage device according to claim 6, wherein the controller is further configured to sequentially migrate, when executing the first migration operation, data units stored in the first target memory units to a second zone among the plurality of zones.

8. A method of operating a storage device, the method comprising:
setting a plurality of zones each corresponding to at least one of a plurality of memory units;
determining a fragmentation value of each of the plurality of zones based on mapping information between a logical address area and a physical address area for a data unit written to each of the plurality of zones; and
determining, as a target of a first migration operation, one or more first target memory units among the plurality of memory units based on the fragmentation value of each of the plurality of zones.

9. The method according to claim 8, further comprising:
storing the mapping information in at least one of a first level map that indicates mapping information between a logical address area and a physical address area of a first unit size, and a second level map that indicates mapping information between a logical address area and a physical address area of a second unit size, the first unit size being larger than the second unit size; and
increasing the determining a fragmentation value of each of the plurality of zones, in response to the second level map that is updated by an operation of writing a first data unit to a first zone among the plurality of zones, a fragmentation value of the first zone.

10. The method according to claim 9, further comprising updating the second level map in response to a determination that a physical address area where the first data unit is written in the first zone and a physical address area where a second data unit written immediately before the first data unit in the first zone are not consecutive to each other.

11. The method according to claim 8, further comprising:
determining, as a target of a second migration operation, one or more second target memory units among the plurality of memory units based on the size of valid data stored in each of the plurality of memory units; and
determining the ratio of a number of the second target memory units to a number of the first target memory units based on a number of free memory units among the plurality of memory units.

12. The method according to claim 11, wherein the determining the ratio of the number of the second target memory units comprises determining the ratio as a first ratio in response to the number of free memory units among the plurality of memory units, which is equal to or smaller than a threshold number,
the determining the ratio of the number of the second target memory units comprises determining the ratio as a second ratio in response to the number of free memory units among the plurality of memory units, which is greater than the threshold number, the first ratio being greater than the second ratio.

13. The method according to claim 8, wherein the determining the one or more first target memory units comprises determining, as the first target memory units, memory units corresponding to a first zone with a greatest fragmentation value among the plurality of zones.

14. The method according to claim 13, further comprising sequentially migrating data units stored in the first target memory units to a second zone among the plurality of zones to execute the first migration operation.
